(19) United States
(12) Patent Application Publication
(10) Pub. No.: US 2019/0234347 A1
(43) Pub. Date: Aug. 1, 2019

(54) CANISTER

(71) Applicant: FUTABA INDUSTRIAL CO., LTD., Okazaki-shi (JP)

(72) Inventor: Makoto Kato, Okazaki-shi (JP)

(21) Appl. No.: 16/250,534

(22) Filed: Jan. 17, 2019

(30) Foreign Application Priority Data
Jan. 26, 2018 (JP) 2018-011560

(51) Int. Cl. F02M 25/08; B01D 53/04

(52) U.S. Cl. CPC F02M 25/0854; B01D 2253/102; B01D 2259/4516; B01D 53/0407

(57) ABSTRACT

A canister is provided which can inhibits generation of a short path due to micronized activated carbon, without using an elastic body such as a spring. One embodiment of the present disclosure provides a canister that absorbs and desorbs evaporated fuel generated in a fuel tank of a vehicle. The canister includes a filling chamber filled with the activated carbon. The filling chamber includes a flowing portion that forms a flow path through which the evaporated fuel flows in a direction crossing a vertical direction, and at least one buffer portion that protrudes above the flowing portion in a vertical direction.

### CROSS-REFERENCE TO RELATED APPLICATIONS

This application claims the benefit of Japanese Patent Application No. 2018-11560 filed on Jan. 26, 2018 with the Japan Patent Office, the entire disclosure of which is incorporated herein by reference.

### BACKGROUND

The present disclosure relates to a canister.

A canister, which inhibits release of evaporated fuel to the atmosphere, is attached to a fuel tank of a vehicle. The canister absorbs the evaporated fuel to activated carbon, desorbs fuel from the activated carbon with aspirated air for purging, and supplies the purged fuel to an engine.

The activated carbon filled in a filling chamber of the canister is micronized due to vibration or the like. The micronized activated carbon generates a gap in a filling chamber 103 as shown in FIG. 4. In a horizontal canister 101 disposed so that the evaporated fuel flows in a horizontal direction, such a gap generates a short path S in which the evaporated fuel does not pass through an activated carbon layer 105, and the evaporated fuel is released to the atmosphere without being absorbed.

Therefore, an elastic body such as a spring which biases the activated carbon in a flow direction of the evaporated fuel is provided to inhibit generation of a gap in the filling chamber (see Japanese Unexamined Patent Application Publication No. 2012-197758).

### SUMMARY

A conventional canister disclosed in the above publication requires a space for arranging a spring, so the size of the canister must be large. In addition to the spring, a grid-like plate member which receives the spring is also required, which results in an increase in number of parts of the canister.

In one aspect of the present disclosure, a canister is provided that can inhibit generation of a short path due to the micronized activated carbon, without using an elastic body such as a spring or the like.

One embodiment of the present disclosure is a canister. The canister comprises a filling chamber filled with activated carbon. The filling chamber includes a flowing portion that forms a flow path through which the evaporated fuel flows in a direction crossing a vertical direction, and at least one buffer portion that protrudes above the flowing portion in the vertical direction.

According to the configuration as above, in an exemplary embodiment, a gap caused by the micronized activated carbon in a horizontal canister is generated in the buffer portion provided above the flowing portion in the vertical direction. Therefore, generation of a gap in the flowing portion is inhibited. As a result, without an elastic body biasing the activated carbon in the flow direction of the evaporated fuel, generation of a short path of the evaporated fuel can be inhibited. Thus, the canister is downsized, and decreased number of parts leads to cost reduction of the canister.

One embodiment of the present disclosure may further comprise a lid that closes an end of the filling chamber in the flow path of the evaporated fuel. The at least one buffer portion may be provided at a position continuous with the lid. According to the configuration as above, the filling chamber does not have a bag structure of which inner side is wider than the opening. Therefore, the activated carbon, which is filled from the end to which the lid of the filling chamber is attached, easily spreads into the filling chamber, and a filling factor of the activated carbon can be increased. Also, workability of filling the activated carbon into the filling chamber is improved.

One embodiment of the present disclosure may comprise one buffer portion as the at least one buffer portion. According to the configuration as such, a region where a gap is generated can be minimized. As a result, decrease in absorption efficiency of the canister can be inhibited.

One embodiment of the present disclosure may further comprise a charge port that takes in the evaporated fuel, and an atmosphere port open to the atmosphere. The charge port may be connected to a first end portion of the filling chamber. The atmosphere port may be connected to a second end portion of the filling chamber. A sectional area of the buffer portion perpendicular to a flow direction of the evaporated fuel in the filling chamber may be larger than a sectional area of the first end portion perpendicular to the flow direction of the evaporated fuel in the filling chamber. The buffer portion may protrude to a position higher than an upper end of the first end portion. According to the configuration as above, generation of a short path of the evaporated fuel can be more reliably inhibited.

In one embodiment of the present disclosure, the filling chamber may be a tubular body. In a section parallel to both an axis of the filling chamber and the vertical direction, a section of an upper surface of the filling chamber may be inclined at a certain angle with respect to the axis of the filling chamber from the first end portion to the second end portion of the filling chamber. According to the configuration as above, the buffer portion can be easily formed. As a result, production efficiency of the canister can be enhanced.

### BRIEF DESCRIPTION OF THE DRAWINGS

Example embodiments of the present disclosure will be described hereinafter with reference to the accompanying drawings, in which:

FIG. 1A is a schematic vertical sectional view showing an initial state of a canister in an embodiment, and FIG. 1B is a schematic vertical sectional view showing a gap generated state of the canister in the embodiment;

FIG. 2 is a schematic vertical sectional view of the canister in an embodiment different from FIG. 1B;

FIG. 3 is a schematic vertical sectional view of the canister in an embodiment different from FIGS. 1B and 2;

FIG. 4 is a schematic vertical sectional view of the canister in which a short path is generated.

### DETAILED DESCRIPTION OF EXEMPLARY EMBODIMENTS

### 1. First Embodiment

[1-1. Configuration]

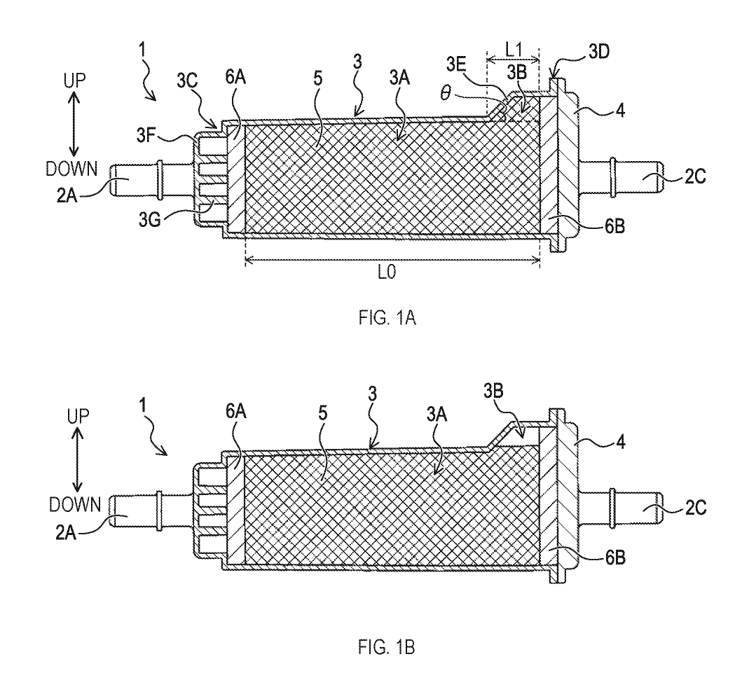

A canister 1 shown in FIG. 1A absorbs and desorbs evaporated fuel generated in a fuel tank of a vehicle. The canister 1 comprises a charge port 2A, a purge port (not shown), an atmosphere port 2C, a filling chamber 3, a lid 4, activated carbon 5, and filters 6A, 6B.

<Port>

The charge port 2A is connected to the fuel tank of the vehicle via piping. The charge port 2A is configured to pass the evaporated fuel generated in the fuel tank into the filling chamber 3.

The purge port is connected to an intake pipe of an engine of the vehicle via a one-way purge valve (not shown). The purge port is configured to discharge the evaporated fuel inside the filling chamber 3 from the filling chamber 3 and supply the evaporated fuel to the engine.

The atmosphere port 2C is connected to a filling port of the vehicle via piping, and is open (through the filling port) to the atmosphere. The atmosphere port 2C releases gas from which the evaporated fuel has been removed to the atmosphere. Also, the atmosphere port 2C takes in external air (that is, purge air) to desorb (that is, purge) the evaporated fuel absorbed in the filling chamber 3. The atmosphere port 2C is located at a position opposite the charge port 2A and the purge port, with the filling chamber 3 interposed therebetween. However, location of each port is not limited to the above position.

<Filling Chamber and Lid>

The filling chamber 3 has a space for storing the activated carbon 5 and absorbing the evaporated fuel received from the charge port 2A. Also, the filling chamber 3 is configured to discharge the absorbed evaporated fuel through the purge port.

The filling chamber 3 is a bottomed tubular body with a first end portion 3C provided with a bottom wall 3F and an open second end portion 3D. The charge port 2A and the purge port are connected to the bottom wall 3F at the first end portion 3C of the filling chamber 3.

The second end portion 3D of the filling chamber 3 is closed with a plate-shaped lid 4. In other words, the lid 4 closes an end of the filling chamber 3 in a flow path of the evaporated fuel. The atmosphere port 2C is connected to the lid 4.

The lid 4 is welded to the second end portion 3D of the filling chamber 3. Also, the lid 4 is disposed in parallel to the bottom wall 3F at the first end portion 3C of the filling chamber 3. A sectional shape perpendicular to a central axis of the filling chamber 3 (that is, parallel to the lid 4) is not particularly limited, and may be a quadrangle or circular shape. In the present embodiment, the filling chamber 3 is located inside the vehicle sideways so that the central axis is in a horizontal direction.

A first filter 6A is located on the inside of the bottom wall 3F of the filling chamber 3. Also, a second filter 6B is located on the inside of the lid 4. The activated carbon 5 is densely filled in a space between the first filter 6A and the second filter 6B of the filling chamber 3.

Each of the first filter 6A and the second filter 6B is configured to retain the activated carbon 5 but to be able to pass the gas. Also, in the present embodiment, an elastic body that biases the activated carbon 5 in a direction crossing the vertical direction (for example, horizontal direction) is not provided between the first filter 6A and the bottom wall 3F of the first end portion 3C, and between the second filter 6B and the lid 4. A plurality of projections 3G which support the first filter 6A are provided between the bottom wall 3F of the first end portion 3C and the first filter 6A.

The filling chamber 3 has a flowing portion 3A and one buffer portion 3B. In other words, the inner space of the filling chamber 3 is partitioned into the flowing portion 3A and the buffer portion 3B.

[Flowing Portion]

The flowing portion 3A forms a flow path through which the evaporated fuel flows in the direction crossing the vertical direction while in contact with the activated carbon 5, that is, while passing through an activated carbon layer.

In the present embodiment, a flow direction of the evaporated fuel in the flowing portion 3A is a horizontal direction, and is parallel to a central axis direction of the filling chamber 3. Also, the flowing portion 3A is configured by a tubular portion of the filling chamber 3, which has the same diameter as the first end portion 3C. The flowing portion 3A may have an increased diameter from the first end portion 3C toward the second end portion 3D at an inclination angle of less than 3°.

[Buffer Portion]

The buffer portion 3B is a portion of the filling chamber 3 protruding above the flowing portion 3A in the vertical direction in a state in which the canister 1 is attached to the vehicle. The buffer portion 3B is formed by partially expanding the tubular body that forms the filling chamber 3.

The buffer portion 3B of the present embodiment is provided at a position in the filling chamber 3 continuous with the lid 4. Therefore, an opening area of the second end portion 3D is a sum of a sectional area of the inner space of the filling chamber 3 at the first end portion 3C and a sectional area of the inner space of the buffer portion 3B at the second end portion 3D.

Specifically, the buffer portion 3B is a portion in vicinity of the second end portion 3D of the tubular body that forms the filling chamber 3, which has a discontinuously increased diameter upward as compared to other portions. In other words, the buffer portion 3B is configured by raising a part or the whole of an upper surface in vicinity of the second end portion 3D of the tubular body in a step shape. The surfaces other than the upper surface in vicinity of the second end portion 3D (that is, side and lower surfaces) do not protrude in a radial direction with respect to the flowing portion 3A. Here, the “upper surface” means a surface of an outer surface of the filling chamber 3 that can be seen from above in the vertical direction in a state in which the canister 1 is located in the vehicle.

A sectional area perpendicular to the flow direction of the evaporated fuel at the second end portion 3D of the filling chamber 3 is larger than a sectional area perpendicular to the flow direction of a portion at the first end portion 3C filled with the activated carbon 5. Also, the buffer portion 3B protrudes to a position higher than an upper end of the first end portion 3C.

The wall of the buffer portion 3B of the filling chamber 3 has the same thickness as the wall of the flowing portion 3A. In other words, in the buffer portion 3B, the wall of the filling chamber 3 is not thinned with respect to other portions.

A raised surface 3E in the upper surface of the buffer portion 3B, which connects with the upper surface of the flowing portion 3A in the flow direction of the evaporated fuel is inclined with respect to an axial direction and a radial direction of the filling chamber 3. The raised surface 3E has an inclination angle θ of, for example, 3° or more with respect to the axial direction of the filling chamber 3.

The buffer portion 3B is provided in a portion in the axial direction of the filling chamber 3. In an exemplary embodiment, an axial length L1 of the buffer portion 3B in the filling chamber 3 is ⅓ or less of an axial length (that is a distance between the first filter 6A and the second filter 6B) L0 of the flowing portion 3A.

<Activated Carbon>

The activated carbon 5 is filled in the filling chamber 3 to form an activated carbon layer. The activated carbon 5, together with the air and the like, absorbs evaporated fuel supplied to the canister 1. Also, the activated carbon 5 desorbs the evaporated fuel by introduction of external air.

An aggregate of known granular activated carbon can be used as the activated carbon 5. Also, in an initial state (that is, state before use of the canister 1), the activated carbon 5 is filled in the entire filling chamber 3, that is, both the flowing portion 3A and the buffer portion 3B.

When the activated carbon 5 is micronized by aging, as shown in FIG. 1B, the activated carbon 5 moves downward by the action of gravity to form a gap in the buffer portion 3B. On the other hand, the activated carbon layer is maintained in the flowing portion 3A which is located below the buffer portion 3B.

The evaporated fuel taken in from the charge port 2A is absorbed to activated carbon 5 mainly in the flowing portion 3A of the filling chamber 3. Gas from which the evaporated fuel has been removed passes the flowing portion 3A and is released from the atmosphere port 2C.

Also, by supplying the air from the atmosphere port 2C, the evaporated fuel absorbed on the activated carbon 5 is discharged from the purge port to the engine. As a result, the air containing the evaporated fuel is supplied to the engine.

[1-2. Effect]

According the embodiment detailed in the above, the following effects can be obtained.

(1a) In an exemplary embodiment, when the canister 1 is horizontally placed, a gap caused by the micronized activated carbon 5 is generated in the buffer portion 3B provided above the flowing portion 3A in the vertical direction. Therefore, generation of a gap in the flowing portion 3A is inhibited. As a result, without an elastic body biasing the activated carbon 5 in the flow direction of the evaporated fuel, generation of a short path of the evaporated fuel can be inhibited. Therefore, the canister 1 is downsized, and decreased number of parts leads to cost reduction of the canister 1.

(1b) The buffer portion 3B is provided at the position continuous with the lid 4. Thus, the activated carbon 5 easily spreads in the filling chamber 3 by filling the activated carbon 5 from the second end portion 3D to which the lid 4 of the filling chamber 3 is attached. As a result, an increase in filling factor of the activated carbon 5 can be achieved. Also, workability of filling the activated carbon 5 into the filling chamber 3 is also improved.

(1c) By providing only one buffer portion 3B in the filling chamber 3, a region where a gap is generated can be minimized. As a result, decrease in absorption efficiency of the canister 1 can be inhibited.

### 2. Second Embodiment

[2-1. Configuration]

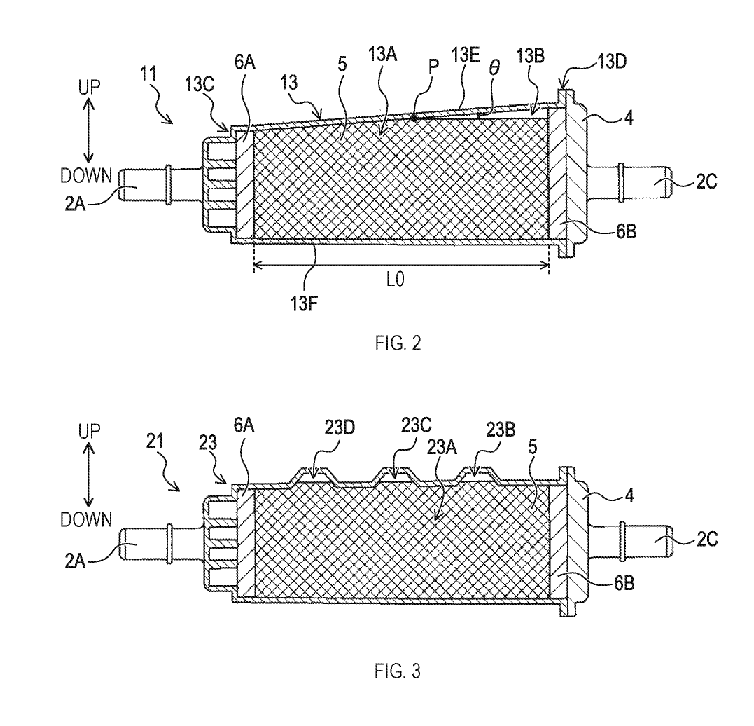

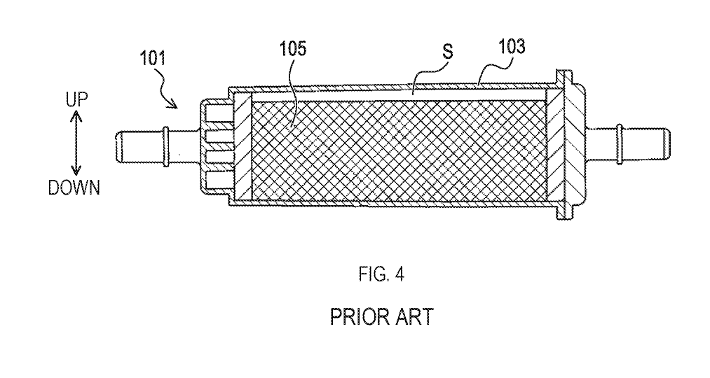

A canister 11 shown in FIG. 2 absorbs and desorbs evaporated fuel generated in a fuel tank. The canister 11 comprises the charge port 2A, the purge port (not shown), the atmosphere port 2C, a filling chamber 13, the lid 4, the activated carbon 5, and the filters 6A, 6B.

The charge port 2A, the purge port, the atmosphere port 2C, the lid 4, the activated carbon 5, and the filter 6A, 6B of the canister 11 are the same as those in the canister 1 of FIG. 1A. Thus, the same reference numerals are given and the description thereof is not repeated.

<Filling Chamber>

The filling chamber 13 is a tubular body that has a continuously increased diameter from a first end portion 13C to a second end portion 13D.

Specifically, in a section parallel to both an axis of the filling chamber 13 and the vertical direction, a section of an upper surface 13E of the filling chamber 13 is inclined at a certain angle with respect to the axis of the filling chamber 13 from the first end portion 13C to the second end portion 13D of the filling chamber 13. The upper surface 13E has an inclination angle θ of, for example, 3° or more with respect to the axis of the filling chamber 13.

The filling chamber 13, like the filling chamber 3 in FIG. 1A, includes a flowing portion 13A and one buffer portion 13B. The flowing portion 13A forms a flow path through which the evaporated fuel flows in a direction crossing the vertical direction. The buffer portion 13B protrudes above the flowing portion 13A in the vertical direction.

In the present embodiment, the buffer portion 13B is positioned above an intermediate point (that is, point where a distance in the axial direction from the first end portion 13C is ½ of the axial length L0 of the flowing portion 13A) P in the axial direction of the filling chamber 13. The upper surface of the buffer portion 13B is flush with a portion of the upper surface of the flowing portion 13A closer to the first end portion 13C than the buffer portion 13B (that is, portion between the intermediate point P and the first end portion 13C).

In the section parallel to both the axis of the filling chamber 13 and the vertical direction, a section of a lower surface (that is, surface opposite the upper surface 13E) 13F of the filling chamber 13 is substantially parallel to the axis of the filling chamber 13. Here, “substantially parallel” means that the inclination angle is 3° or less.

[2-2. Effect]

According the embodiment detailed in the above, the following effect can be obtained.

(2a) By continuously increasing the diameter of the tubular filling chamber 13, the buffer portion 13B protruding upward in the vertical direction can be easily formed. As a result, production efficiency of the canister 11 can be enhanced.

### 3. Other Embodiments

The embodiments of the present disclosure have been described in the above. The present disclosure is not limited to the embodiments described above, and can take various forms.

(3a) In the canister 1 of the above-described embodiment, the buffer portion 3B may not be necessarily provided at a position continuous with the lid 4. Also, the filling chamber 3 may have a plurality of buffer portions 3B.

For example, like a canister 21 shown in FIG. 3, the filling chamber 23 may include the flowing portion 23A, and a plurality of buffer portions 23B, 23C, 23D spaced apart from each other in the axial direction. In the canister 21 shown in FIG. 3, all the plurality of buffer portions 23B, 23C, 23D are separated from the lid 4. Such buffer portions 23B, 23C, 23D that function as beads can increase stiffness of the filling chamber 23.

(3b) The canister 1, 11 of the above-described embodiments may comprise one or more sub chambers filled with the activated carbon. The sub chamber(s) is(are) located on a downstream side of the filling chamber 3, 13. In case that a sub chamber(s) is(are) provided, the atmosphere port 2C is provided on a downstream end of the sub chamber(s). Further, a buffer portion equivalent to the filling chamber 3, 13 may be provided in the sub chamber(s).

(3c) In the canister 1, 11 of the above-described embodiments, the flow direction of the evaporated fuel in the flowing portion 3A, 13A may not necessarily coincide with the horizontal direction. The flow direction of the evaporated fuel may be inclined with respect to the horizontal direction.

(3d) A function of a single component in above-described embodiments may be distributed as a plurality of components or functions of a plurality of components may be integrated into a single component. It is also possible to omit a part of the configuration of the above embodiments. Further, at least a part of the configuration of one of the above embodiments may be added, substituted, or the like, to the configuration of the other of the above embodiments. Any aspects within the technical idea specified from the wording of the claims are embodiments of the present disclosure.

What is claimed is:

1. A canister comprising:
a filling chamber filled with activated carbon,
the filling chamber including:
a flowing portion that forms a flow path through which the evaporated fuel flows in a direction crossing a vertical direction; and
at least one buffer portion that protrudes above the flowing portion in the vertical direction.

2. The canister according to claim 1, further comprising:
a lid that closes an end of the filling chamber in the flow path of the evaporated fuel, wherein
the at least one buffer portion is provided at a position continuous with the lid.

3. The canister according to claim 1, comprising:
one buffer portion as the at least one buffer portion.

4. The canister according to claim 1, further comprising:
a charge port that takes in the evaporated fuel; and
an atmosphere port open to the atmosphere, wherein
the charge port is connected to a first end portion of the filling chamber,
the atmosphere port is connected to a second end portion of the filling chamber,
a sectional area of the buffer portion perpendicular to a flow direction of the evaporated fuel in the filling chamber is larger than a sectional area of the first end portion perpendicular to the flow direction of the evaporated fuel in the filling chamber, and
the buffer portion protrudes to a position higher than an upper end of the first end portion.

5. The canister according to claim 1, wherein
the filling chamber is a tubular body, and,
in a section parallel to both an axis of the filling chamber and the vertical direction, a section of an upper surface of the filling chamber is inclined at a certain angle with respect to the axis of the filling chamber from the first end portion to the second end portion of the filling chamber.
